(19) United States
(12) Patent Application Publication
(10) Pub. No.: US 2012/0081123 A1
(43) Pub. Date: Apr. 5, 2012

(54) UNIVERSAL AUTOMOTIVE IGNITION PICKUP ASSEMBLY

(76) Inventors: Bernie C. Thompson, Tijeras, NM (US); Neal R. Pederson, Los Alamos, NM (US)

(21) Appl. No.: 12/896,526

(22) Filed: Oct. 1, 2010

(51) Int. Cl. F02P 17/00

(52) U.S. Cl. 324/379

(57) ABSTRACT

The present invention is a Universal Automotive Ignition Pickup Assembly that produces an ignition secondary voltage waveform that can be monitored by an oscilloscope or microprocessor. This is accomplished with a sensing probe that can be capacitive coupled; inductively coupled; or capacitive and inductively coupled at the same time. Due to the ability of a pickup to be capacitive and inductive at the same time, the ignition voltage waveforms are clear and concise from secondary ignition wires to a multitude of different ignition coil types.

### FIELD OF THE INVENTION

An automotive capacitive inductive ignition pickup assembly that produces a voltage output signal which is read by a diagnostic oscilloscope or microprocessor. This ignition voltage signal is produced by the capacitive inductive pickup assembly being aligned to the electromagnetic field of a step-up transformer and having this field produce induction in the pickup assembly; or having the pickup assembly capacitive coupled to the secondary ignition wire during high voltage discharge. In either instance a voltage signal that mirrors the step up transformer secondary ignition voltage is produced within the capacitive inductive pickup assembly that is connected with two parallel conductive wires that are isolated from the step up transformer circuits; one being of a high potential; and one being of a low potential; to the diagnostic oscilloscope or microprocessor.

### DESCRIPTION OF PRIOR ART

In a patent by Capek; U.S. Pat. No. 3,959,725; This disclosure shows the ignition secondary system being displayed on an oscilloscope. The pickup probe is comprised of a planar sheet of conductive metal and a capacitor for tuning the sensor. In this format the pickup probe is connected to the oscilloscope and the vehicles chassis ground. This configuration only allows the pickup probe to be a capacitive sensing device for an ignition coil.

In a patent by Becker; U.S. Pat. No. 5,004,984; This disclosure shows a device that will only pickup ignition signals for a specific engine with a specific mounting structure and sensing probes position in a predetermined position. The sensing coils are air cored being wrapped around a plastic bobbin with end plates which is of a non magnetizable material. The coil and bobbin are then covered at one end with a cylindrical magnetizable metal shield. Since this configuration is based on a particular engine ignition coil design it is very limited.

In a patent by Bumen; U.S. Pat. No. 5,237,278; This disclosure shows a device that will show an ignition signal from the secondary winding of a step up transformer. A capacitive electrode for a capacitive signal receiver is manufactured inside the transformer in a predetermined location referred to as the measuring point. This configuration is very limited since it would need to be manufactured into the ignition coil assembly.

In a patent by Dittmann; U.S. Pat. No. 5,444,376; This disclosure shows a device that can perform high-voltage measurements of a distributorless ignition system with multiple coils. It does this by the use of two capacitive pickups that have their signals combined together by a circuit arrangement. This pickup is then calibrated or tuned by a capacitor. This configuration only allows the pickup probe to be a capacitive sensing device for system having at least two ignition coils.

In a patent by Fong; U.S. Pat. No. 6,396,277; This disclosure shows a device that measures voltage signals of coil on plug type with a capacitive pickup assembly. It is comprised of an insulating substrate with two planner conductive elements each located on opposite sides of the substrate. The first conductive element is connected to the signal; the second conductive element is connected to the ground. The size of each conductive element can be changed to tune the pickup. This configuration only allows the pickup probe to be a capacitive sensing device for coil on plug systems.

In a patent by Kravis; U.S. Pat. No. 6,426,626; This disclosure shows a device for testing coils and spark plugs. In this device the coil assembly is plugged to an apparatus that powers the coils and fires the coils. The device then monitors the step up transformer's primary circuit during high voltage output for the primary ignition voltage signal that is produced; this signal is then compared to a predetermined signal. Newer coil on plug systems do not have a primary connection. Instead the driver or transistor is built into the coil assembly making this a very limited testing device.

In a patent by Duggan; U.S. Pat. No. 6,825,648; This disclosure shows a device comprising an interface box, oscilloscope connection, and several flexible inductive pickups that wrap around an ignition coil. Each of the flexible pickups are comprised of flexible copper that can be wrapped around the ignition coil if access is permitted. The pickup then sends a signal to the interface box which then sends a signal to the oscilloscope. Many coil on plug systems are not accessible or are sunk into the engine head and due not allow access to wrap the ignition coil making this is a very limited system.

In a patent by McQueeney; U.S. Pat. No. 6,940,283; This disclosure shows a device for detecting the ignition signal from coil on plug systems and a diagnostic system to test these ignition signals. It comprises an adjustable probe that can be put into two predetermined positions and locked to these positions. The probe consists of an insulating substrate with one or two planner conductive elements located on an insulated substrate comprising a capacitive pickup; or an air wound coil pickup; or an air wound coil etched onto a circuit board. The base is complicated and costly and the signal would be changed depending on which probe was in use. This system is limited to only coil on plug systems.

In a patent by Dittmann; U.S. Pat. No. 7,750,638; This disclosure shows a device for detecting the ignition signal with a handle that is connected to a flexible tube that contains a sensing probe. The sensing probe is of a capacitive primary detector that is used with a voltage divider circuit to produce the ignition signal. This configuration only allows the pickup probe to be a capacitive sensing device.

### BACKGROUND OF THE INVENTION

The automotive step-up transformer, also known as an ignition coil, has been used on the internal combustion engine to ignite the air-fuel charge contained in the cylinder for over a hundred years. This step up transformer takes a low voltage high current pole (primary winding) and changes it into a high voltage low current pole (secondary winding).

This high voltage is discharged from the secondary winding across the spark plug electrodes. This high voltage ionizes across the spark plug electrodes creating a plasma state from which a heat shock wave is produced, breaking the hydrocarbon molecules apart, thus releasing the molecules energy.

This high voltage ionization makes certain resistive changes during discharge that can be monitored with an oscilloscope or a microprocessor. These voltage changes indicate how the combustion process occurred and shows problems such as; lean air fuel mixture, rich air fuel mixture, carbon traces, arcing outside the combustion chamber, weak spark discharge, high resistance in secondary circuit, low resistance in secondary circuit, and turbulence from engine mechanical problems. When a problem occurs to ignite this air-fuel charge an unwanted engine misfire will occur.

It is desirable to monitor the secondary ignition signal so that the cause of such a misfire can be located. With the technological changes of modern vehicles the ignition systems have drastically changed. Many new ignition systems have emerged over the years making it very difficult to acquire and monitor ignition voltage waveforms from all of these different ignition systems.

The ignition pickups that are currently available cannot provide ignition signals from all of these different ignition systems. What is needed in the automotive repair industry is a device that can pickup ignition signals from all types of ignition systems; these systems include conventional distributor ignition, distributorless ignition, waste spark ignition, coil near plug ignition, and coil on plug ignition.

As seen in the prior art, these ignition diagnostic systems are specific to certain ignition systems and are not generic nor wide based. In fact the prior art is very limited and inadequately addresses the automotive industry's need for an ignition pickup. The present invention can easily be used on all ignition systems to provide an oscilloscope or microprocessor this critical ignition voltage waveform.

### SUMMARY OF THE INVENTION

The present invention is a Universal Automotive Ignition Pickup Assembly that produces an ignition secondary voltage waveform that can be monitored by an oscilloscope or microprocessor. It is an objective of the invention to be able to easily connect and produce an ignition waveform from all ignition systems; these systems include conventional distributor ignition, distributorless ignition, waste spark ignition, coil near plug ignition, and coil on plug ignition.

This is accomplished with a sensing probe that can be capacitive coupled; inductively coupled; or capacitive and inductively coupled at the same time. Due to the ability of a pickup to be capacitive and inductive at the same time, the ignition voltage waveforms are clear and concise from secondary ignition wires to a multitude of different ignition coil types. FIG. 1, FIG. 2, FIG. 3, FIG. 4 shows the invention working on a multitude of different systems. The ability of the ignition pickup is enhanced by a method to easily adapt the pickup by attaching either to a secondary ignition wire; or to many different types, configurations, and sizes of ignition coils. These unique abilities of the invention make the use of the Universal Automotive Ignition Pickup Assembly quite easy.

These and other objects of the present invention will become apparent to those skilled in this art upon reading the accompanying description, drawings, and claims set forth herein.

### BRIEF DESCRIPTION OF THE DRAWINGS

FIG. 1 This is an ignition voltage waveform taken with the Universal Automotive Ignition Pickup Assembly, form a 1995 ford truck 5.0 L with a convention distributor system, taken on the secondary ignition wire.

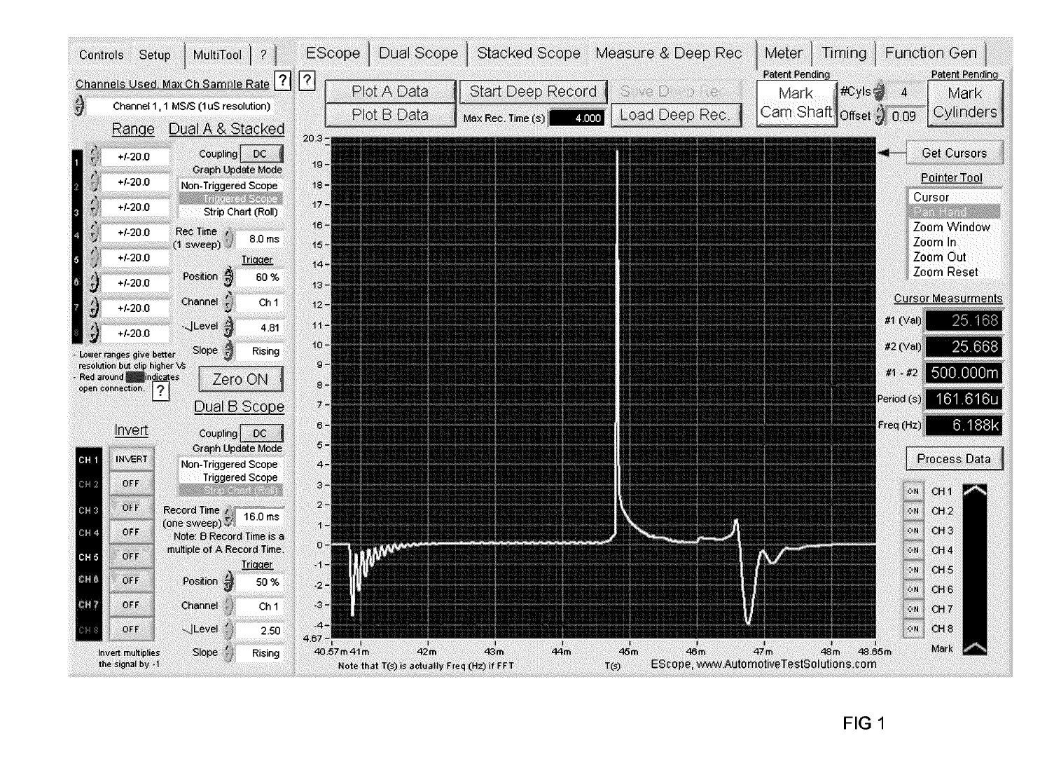

FIG. 2 This is an ignition voltage waveform taken with the Universal Automotive Ignition Pickup Assembly, from a 1998 mazda 626 2.5 L with a waste spark ignition system, taken on the secondary ignition wire.

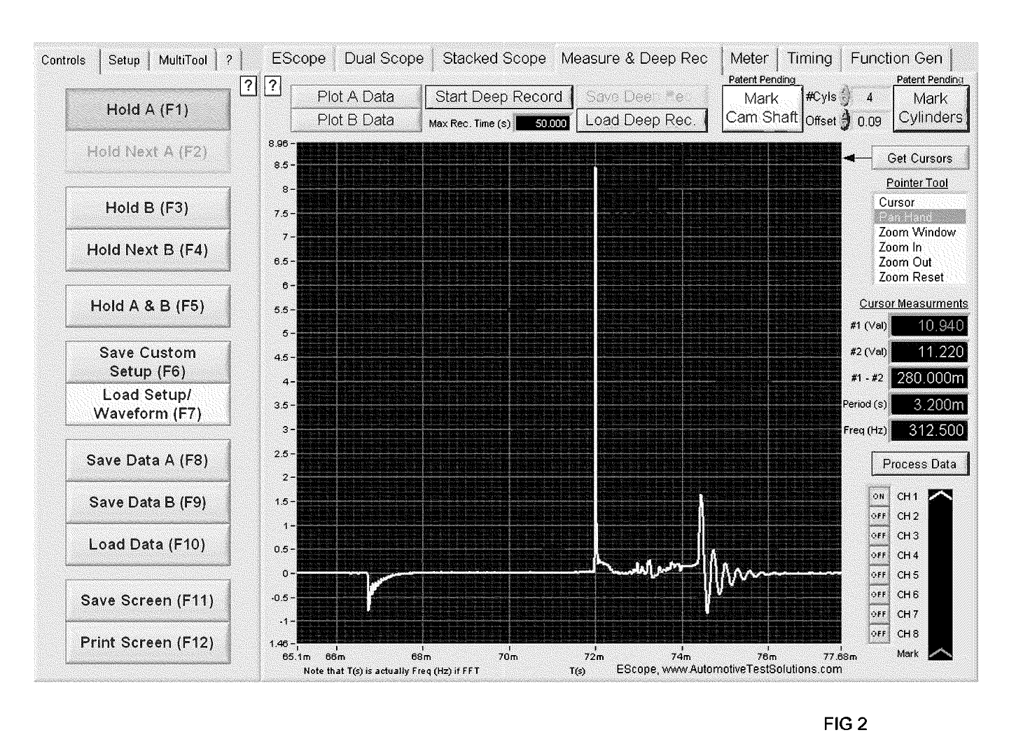

FIG. 3 This is an ignition voltage waveform taken with the Universal Automotive Ignition Pickup Assembly, form a 2009 chevy truck 5.3 L coil near plug system, taken on the ignition coil.

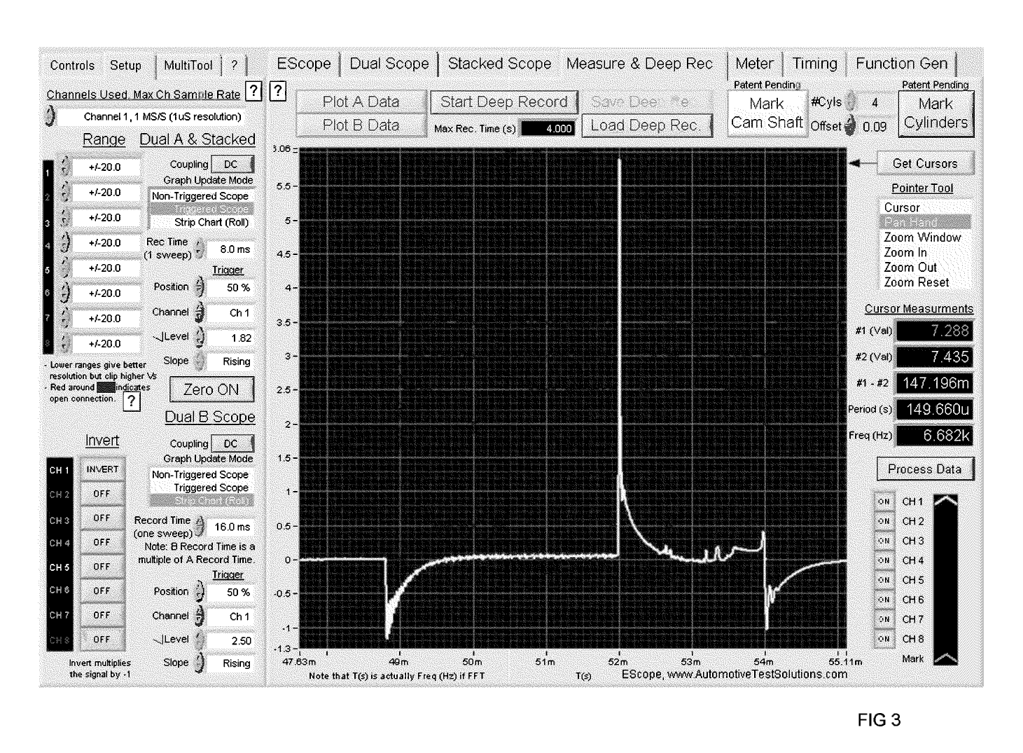

FIG. 4 This is an ignition voltage waveform taken with the Universal Automotive Ignition Pickup Assembly, form a 2005 nissan altima 2.5 L with a coil on plug system, taken on the ignition coil.

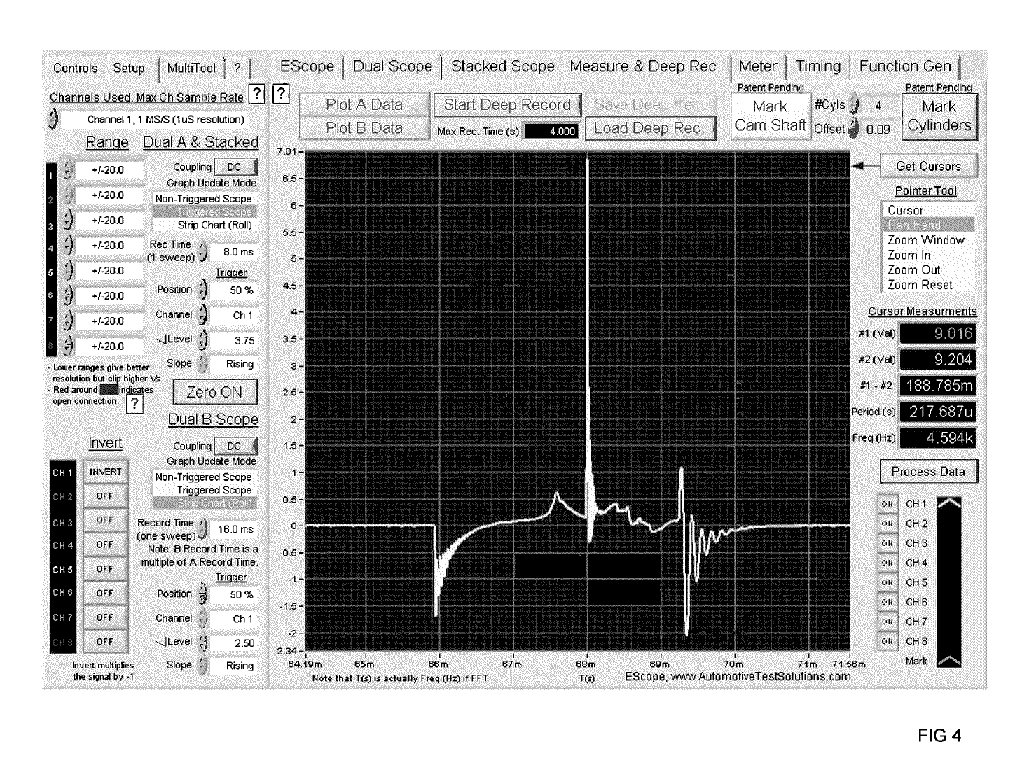

FIG. 5 This is a drawing of the Universal Automotive Ignition Pickup Assembly.

FIG. 6 This is a drawing of the Universal Automotive Ignition Pickup Assembly, on a coil on plug system, with a connection to a oscilloscope or microprocessor.

FIG. 7 This is a drawing of the Universal Automotive Ignition Pickup Assembly on a secondary ignition wire, from a waste spark ignition system, with a connection to an oscilloscope or microprocessor

FIG. 8 This is a drawing of the mounting clip system for the Universal Automotive Ignition Pickup Assembly for a coil on plug system.

FIG. 9 This is a drawing of the various mounting clips for the Universal Automotive Ignition Pickup Assembly

FIG. 10 This is a drawing of the mounting clip for the Universal Automotive Ignition Pickup Assembly for a secondary ignition wire.

### DETAILED DESCRIPTION OF THE INVENTION

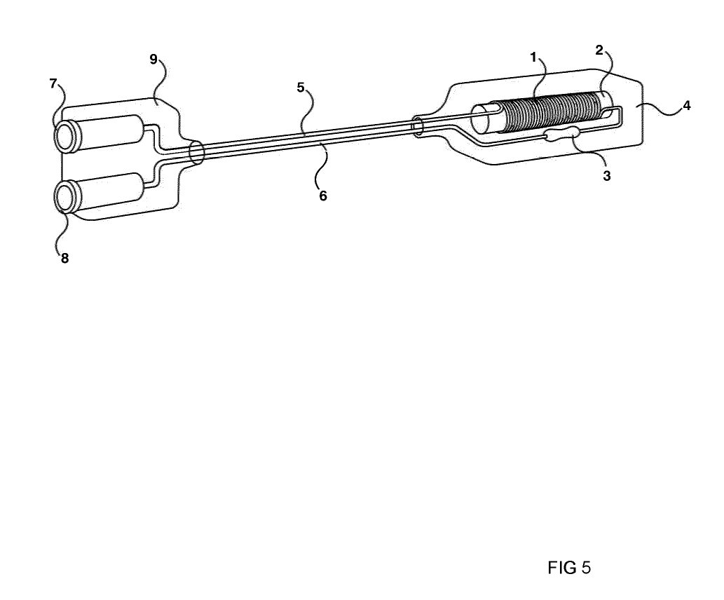

FIG. 5 shows the ignition pickup of the best mode contemplated by the inventors of the Universal Automotive Ignition Pickup Assembly according to the concepts of the present invention. The ignition pickup is comprised of a conductor 1 that is wound around a magnetizable center core 2. The preferred conductor is made of copper and is wound to form a coil consisting of many tight turns of winding. These windings will be constructed so the diameters of the turns are as large as possible. The space confinement that the ignition pickup will need to fit into in order to attach to various ignition coils will set the maximum diameter of the winding. The preferred center core is made of ferrite and is constructed in the format of a rod. The rod is as long and thick as possible. Again the space confinements that the pickup will need to fit into in order to attach to various ignition coils will set the maximum rod length and diameter. The preferred wrap of conductive wire around the magnetizable rod will be of a tight wind.

A device 3 is placed in series with the conductor at one end of the coil winding. This device will divide the circuit between that of a high potential (positive) and that of a low potential (negative). This device will preferably be a silicon resistor. The ignition pickup will be incased or housed inside of 4, which consists of a non-magnetizable material. The preferred material to make the housing for the ignition pickup will be high temperature plastic. This plastic will be color coded to match the oscilloscope trace colors. These colors include; yellow, red, green, blue, white, purple, orange, and brown.

Two conductive leads will be attached to the ignition pickup; lead 5 will be of a high potential; lead 6 will be of a low potential. These two leads 5 and 6 will connect to a means of coupling the ignition pickup to an oscilloscope or microprocessor. The preferred coupling connection 7 and 8 are banana sockets. These banana sockets are colored coded red for high potential, connection 7; and black for low potential, connection 8. These banana sockets will be incased or housed in 9 a non-magnetizable material. The preferred material to incase the banana sockets in will be high temperature plastic. This plastic will be color coded to match the oscilloscope trace colors. These colors include; yellow, red, green, blue, white, purple, orange, and brown.

This ignition pickup coil winding can also be constructed with an air center core. However the ignition signal is diminished due to the lack of capacitance and induction that is present. This capacitive reduction is due to the coil windings no longer being able to capacitive couple with the magnetizable center core. The induction properties are also reduced with an air core construction. The magnetizable center core significantly amplifies the induction properties within the ignition pickup winding.

This ignition pickup coil winding can also be constructed with a magnetic center core. However, when the ignition pickup has a magnetic core it becomes very directional and must be properly aligned to the ignition coil's magnetic field. This means that a special base must be used that allows the pickup to be rotated 360 degrees from the ignition coil housing. When the base is rotated in relation to the ignition coil it allows the proper alignment to occur with the ignition pickup coil. This allows for the highest amplification of the ignition signal voltage. Additionally, when the core is of a magnetic material the capacitive coupling is diminished to a secondary ignition wire.

As any one skilled in the art would understand if a magnetizable center core, air center core, or a magnetic center core was used with a conductor that had some amount of resistance to make the winding with, the winding it self would set up a circuit which would divide the circuit between that of a high potential and that of a low potential. Therefore no device such as a resistor would be needed. One such example of this would be a very thin very long conductor.

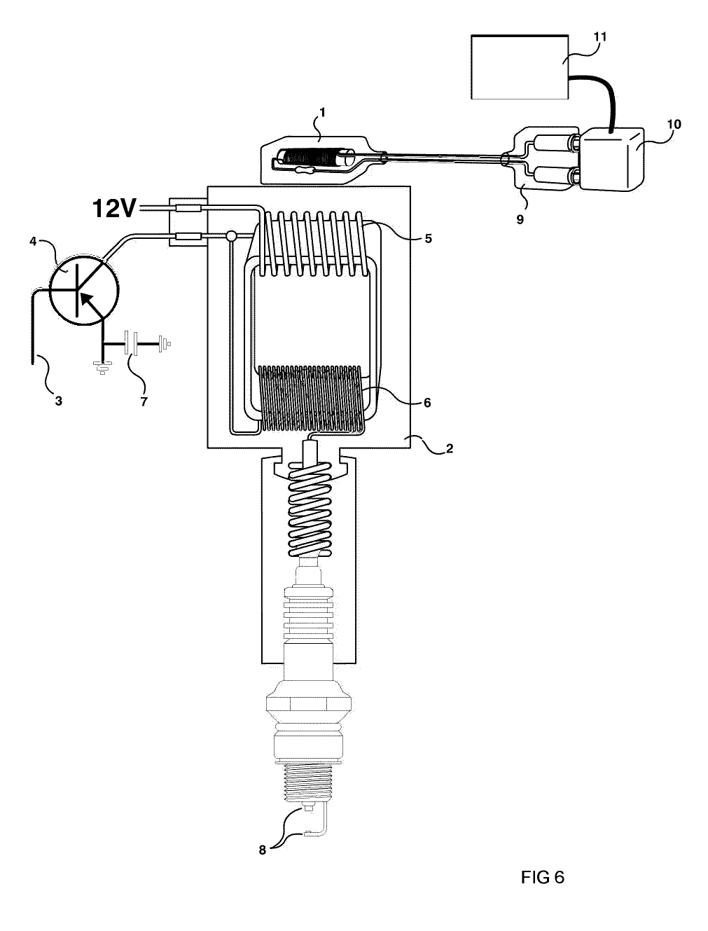

FIG. 6 shows the inventions preferred embodiment 1 placed on a coil on plug system 2. When the control circuit 3 is turned on, transistor 4 allows current to flow through the primary ignition coil winding 5. As this current flows through the primary winding 5 the electrical energy is stored in a magnetic energy field around the primary winding 5, induction occurs from this primary field in motion in the ignition secondary winding 6 and the ignition pickup coil 1.

Once the current has reached the point of saturation within the primary winding 5, and the point at which the piston position is correct, control 3 is shut off. When control 3 is shut off transistor 4 is also shut off. This in turn shuts the current flowing through the primary winding 5 off. The stored magnetic energy around the primary winding 5 flows back into the conductor of the primary winding 5 in an effort to stabilize the current within the primary circuit. The current from the primary winding 5 passes through the capacitor 7 allowing a very rapid primary magnetic field decay. This very fast moving magnetic field induces voltage into the secondary winding 6 and ignition pickup 1.

As this induction voltage increases in the secondary winding 6 the high voltage applies pressure on the spark plug electrodes 8. This high voltage energy applies enough energy to start ionization of the spark plug electrodes 8. Once ionization current is started across the spark plug electrodes , avalanche current starts to flow across the spark plug electrodes draining the electrical energy from the secondary winding 6.

As the current changes in the secondary winding so does the magnetic field around the secondary winding. This in turn creates induction in the primary winding and in the ignition pickup 1. These magnetic movements or fluctuations in the ignition coil windings are directly related to the spark plug ionization in the combustion chamber. Therefore these magnetic movements or fluctuations show the combustion process that has occurred within the engines cylinder.

This combustion chamber process can be induced into the ignition pickup coil and can be coupled to an oscilloscope or microprocessor showing the present combustion process within the engine cylinder. This will indicate if a problem is present or not, and if a problem is present it will indicate what failure has occurred within the engine cylinder.

There will also be a capacitive coupling between all coil windings; the primary coil winding 5, the secondary coil winding 6, and the ignition pickup coil winding 1. During the build up and decay of the magnetic field in the ignition coil 2, the ignition pickup coil 1 will have induction and capacitance that will setup a potential difference within the coil windings. This potential buildup within the ignition pickup 1 will mirror the secondary winding's magnetic field movements. This potential difference will be present in the leads and connector 9. The oscilloscope or microprocessor 11 will connect to connector 9 with connector 10 thus reading this potential difference.

This same process described above to discharge an ignition coil will take place in conventional distributor ignition systems, waste spark systems, distributorless ignition systems, and coil near plug ignition systems. The difference here is a secondary ignition wire will be used to carry the current to the spark plug.

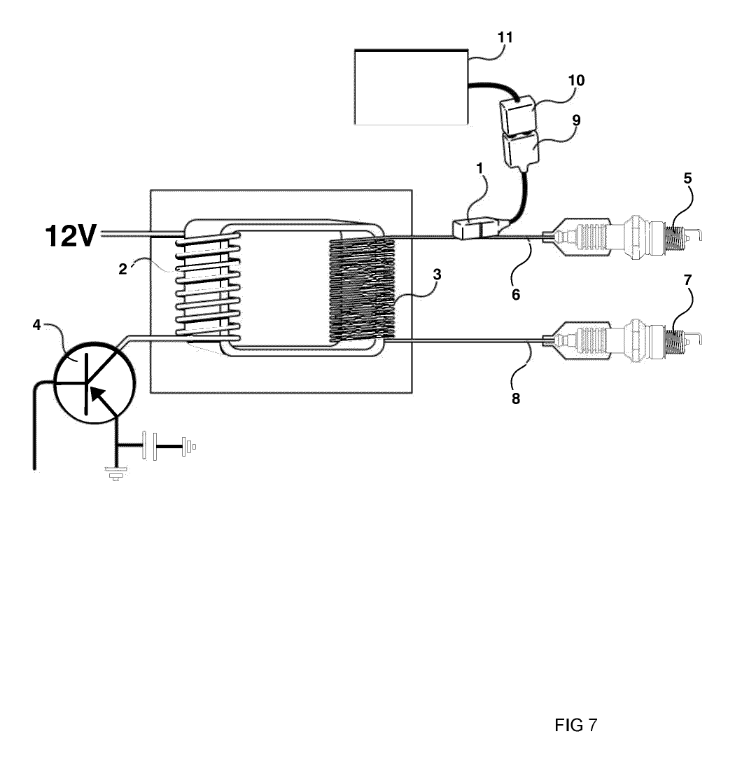

FIG. 7 shows a waste spark ignition system comprising of a; primary winding 2, secondary winding 3, control transistor 4, positive spark plug 5, positive secondary ignition wire 6, negative spark plug 7, negative secondary ignition wire 8. The ignition pickup coil 1 will be placed on the ignition wire. In this position the ignition pickup coil will capacitive couple to the ignition wire, being that of positive potential or being that of negative potential.

During the buildup and discharge of high voltage from the ignition coil, the ignition secondary wire is connected to the secondary winding 3. Since this ignition wire is directly connected to the secondary winding 3, during the build up and decay of the magnetic field the secondary wire 6 or 8 will be capacitive coupled to the ignition pickup coil 1. This capacitive field will be set up between the conductor of the ignition wire 6 or 8, the ignition pickup coil 1 windings, and the magnetizable center core.

This capacitive coupling will setup a potential difference within the ignition pickup coil windings. This potential build up within the ignition pickup 1 will mirror the secondary winding's magnetic field movements. This potential difference will be present in the leads and connector 9. The oscilloscope or microprocessor 11 will connect to connector 9 with connector 10 thus reading this potential difference.

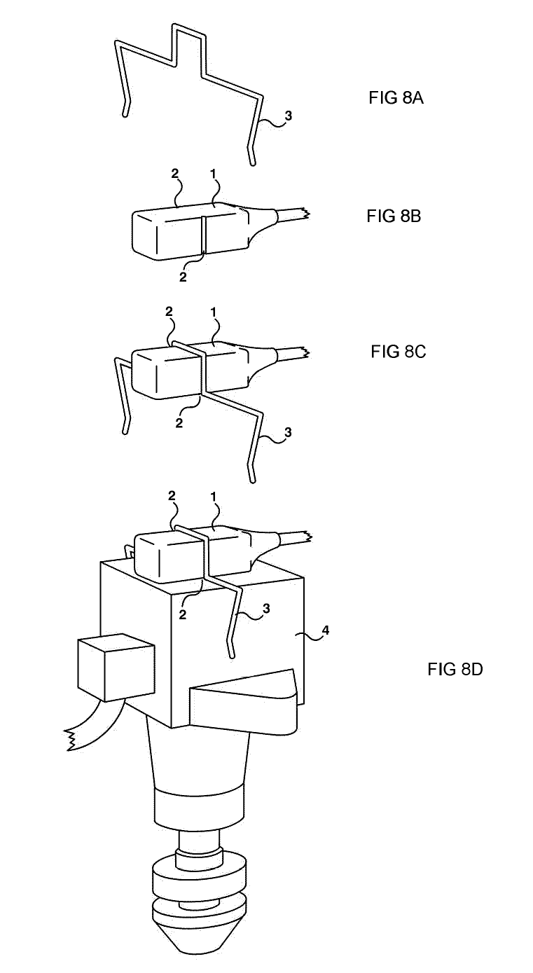

FIG. 8 shows the mounting structure for the ignition pickup coil. The ignition pickup coil housing 1 has one groove 2 down each side. These side grooves 2 will align and hold several detachable clips 3 to the ignition pickup coil 1. The ignition pickup coil will then be placed on coil 4 and held in place by clip 3.

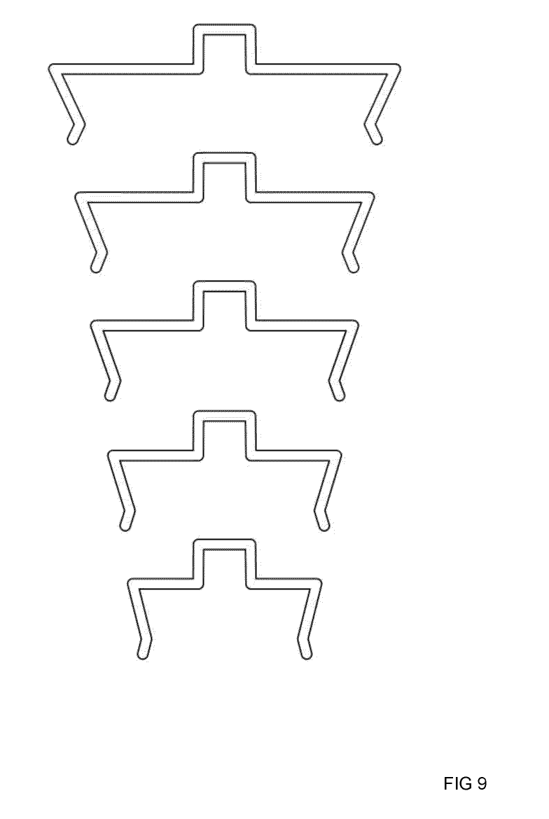

FIG. 9 shows the multiple attaching clips that will fit the grooves in the pickup housing but will consist of different external sizes to fit different ignition coil configurations. Each clip will be of a different size configuration so that the ignition pickup coil may easily be attached to many different ignition coil configurations. The preferred material for the attaching clips will be stainless steel wire.

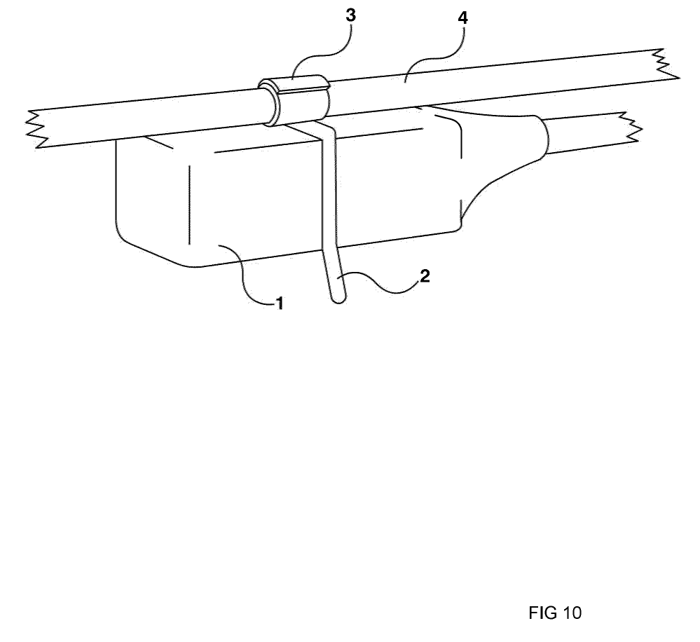

FIG. 10 shows a different clip assembly for secondary ignition wires. The attaching clip will be comprised of a clip 2 that will fit the grooves in the pickup housing 1, Velcro 3 will attached to the clip 2, this will allow the Velcro to wrap around an ignition wire 4. This will allow the ignition pickup coil 1 to be held very close to the secondary ignition wire 4.

The ability to quickly remove and change different mounting clips to attach the ignition pickup coil to various ignition coils and secondary ignition wires with the ability of the pickup to be capacitive inductive in nature makes this a truly universal ignition pickup assembly.

What is claimed is:

1. A universal automotive ignition pickup, comprising: a coil winding that has at least one turn of a conductive material around a magnetizable center core; with a means of coupling said coil circuit to an oscilloscope or microprocessor.

2. A universal automotive ignition pickup, comprising: a coil winding that has at least one turn of a conductive material around a magnetizable center core with a device placed in series to the winding so as to divide the circuit into that of a high potential and that of a low potential; with a means of coupling said coil circuit to an oscilloscope or microprocessor.

3. A universal automotive ignition pickup according to claim 2, wherein said coil winding, magnetizable center core, and device are housed within a non-magnetic material.

4. A universal automotive ignition pickup according to claim 3, wherein a non-magnetic material is color coded to match oscilloscope trace colors; yellow, red, green, blue, white, purple, orange, and brown.

5. A universal automotive ignition pickup according to claim 3, wherein the pickup coil housing has grooves for multiple attaching clips.

6. A universal automotive ignition pickup according to claim 3, wherein the multiple attaching clips will fit the grooves in the pickup housing but will consist of different sizes to fit different ignition coil configurations.

7. A universal automotive ignition pickup according to claim 3, wherein the multiple attaching clips will consist of a clip that will fit the grooves in the pickup housing; and Velcro will be attached to said clip to wrap around a secondary ignition wire.

8. A universal automotive ignition pickup according to claim 2, wherein the connection for an oscilloscope or microprocessor are connected with banana sockets that are colored coded red for high potential, and black for low potential.

9. A universal automotive ignition pickup according to claim 2, wherein the connection for an oscilloscope or microprocessor are connected with banana sockets and are housed in a non-magnetic material that is color coded to match oscilloscope trace colors; yellow, red, green, blue, white, purple, orange, and brown.

10. A universal automotive ignition pickup, comprising: a coil winding that has at least one turn of a conductive material around a air center core; with a means of coupling said coil circuit to an oscilloscope or microprocessor.

11. A universal automotive ignition pickup, comprising: a coil winding that has at lest one turn of a conductive material around an air center core with a device placed in series to the winding so as to divide the circuit into that of a high potential and that of a low potential; with a means of coupling said coil circuit to an oscilloscope or microprocessor.

12. A universal automotive ignition pickup according to claim 11, wherein said coil winding, air center core, and device are housed within a non-magnetic material.

13. A universal automotive ignition pickup according to claim 12, wherein a non-magnetic material is color coded to match oscilloscope trace colors; yellow, red, green, blue, white, purple, orange, and brown.

14. A universal automotive ignition pickup according to claim 12, wherein the pickup coil housing has grooves for multiple attaching clips.

15. A universal automotive ignition pickup according to claim 12, wherein the multiple attaching clips will fit the grooves in the pickup housing but will consist of different sizes to fit different ignition coil configurations.

16. A universal automotive ignition pickup according to claim 12, wherein the multiple attaching clips will consist of a clip that will fit the grooves in the pickup housing; and Velcro will be attached to said clip to wrap around a secondary ignition wire.

17. A universal automotive ignition pickup according to claim 11, wherein the connection for an oscilloscope or microprocessor are connected with banana sockets that are colored coded red for high potential, and black for low potential.

18. A universal automotive ignition pickup according to claim 11, wherein the connection for an oscilloscope or microprocessor are connected with banana sockets and are housed in a non-magnetic material that is color coded to match oscilloscope trace colors; yellow, red, green, blue, white, purple, orange, and brown.

19. A universal automotive ignition pickup, comprising: a coil winding that has at least one turn of a conductive material around a magnetic center core; with a means of coupling said coil circuit to an oscilloscope or microprocessor.

20. A universal automotive ignition pickup, comprising: a coil winding that has at lest one turn of a conductive material around a magnetic center core with a device placed in series to the winding so as to divide the circuit into that of a high potential and that of a low potential; with a means of coupling said coil circuit to an oscilloscope or microprocessor.

21. A universal automotive ignition pickup according to claim 20, wherein said coil winding, magnetic center core, and device are housed within a non-magnetic material.

22. A universal automotive ignition pickup according to claim 21, wherein a non-magnetic material is color coded to match oscilloscope trace colors; yellow, red, green, blue, white, purple, orange, and brown.

23. A universal automotive ignition pickup according to claim 21, wherein the pickup coil housing has grooves for multiple attaching clips.

24. A universal automotive ignition pickup according to claim 21, wherein the multiple attaching clips will fit the grooves in the pickup housing but will consist of different sizes to fit different ignition coil configurations.

25. A universal automotive ignition pickup according to claim 21, wherein the mounting structure will hold automotive ignition pickup and rotate 360 degrees from ignition coil housing.

26. A universal automotive ignition pickup according to claim 21, wherein the multiple attaching clips will consist of a clip that will fit the grooves in the pickup housing; and Velcro will be attached to said clip to wrap around a secondary ignition wire.

27. A universal automotive ignition pickup according to claim 20, wherein the connection for an oscilloscope or microprocessor are connected with banana sockets that are colored coded red for high potential, and black for low potential.

28. A universal automotive ignition pickup according to claim 20, wherein the connection for an oscilloscope or microprocessor are connected with banana sockets and are housed in a non-magnetic material that is color coded to match oscilloscope trace colors; yellow, red, green, blue, white, purple, orange, and brown.
